(19) United States
(12) Patent Application Publication
(10) Pub. No.: US 2025/0001802 A1
(43) Pub. Date: Jan. 2, 2025

(54) WHEEL MOUNTING GUIDE BAR

(71) Applicant: COUNTERACT BALANCING BEADS INC., Guelph (CA)

(72) Inventor: Daniel LEBLANC, Guelph (CA)

(21) Appl. No.: 18/596,750

(22) Filed: Mar. 6, 2024

Related U.S. Application Data
(60) Provisional application No. 63/451,667, filed on Mar. 13, 2023.

(51) Int. Cl. B60B 29/00

(52) U.S. Cl. CPC B60B 29/001

(57) ABSTRACT

The disclosure is directed at a wheel mounting guide bar that is used to assist in the replacement of wheels on a vehicle. The guide bar includes a shaft portion; a sleeve portion, the sleeve portion sized to fit a stud on a wheel hub; and a connector connecting the shaft portion to the sleeve portion, the connector enabling the sleeve portion to move with respect to the shaft portion.

### CROSS-REFERENCE TO OTHER APPLICATIONS

The disclosure claims priority from U.S. Provisional Application No. 63/451,667 filed Mar. 13, 2023, which is hereby incorporated by reference.

### FIELD

The disclosure is directed generally at the automotive sector, and more specifically, at a wheel mounting guide bar.

### BACKGROUND

Vehicles have been utilized for transportation purposes and recreational purposes for quite some time. Many vehicles include a set of wheels that assist the vehicle to travel or move from location to location over different terrain. Over time, the wheels may require replacement. This may be due to wear and tear on the tires, an accident experienced by the vehicle or damage to one of the wheels which render the wheel unusable.

In order to replace a wheel, a user has to unmount or remove the old wheel before mounting a replacement wheel to the wheel hub. Once the old wheel is removed, the user manually lifts the replacement wheel and then attempts to align the stud holes of the replacement wheel with corresponding studs on the wheel hub. Not only is the wheel heavy (which makes prolonged lifting difficult and onerous), the user can only rely on their eyesight to align the studs and stud holes. If it is not correctly aligned on the first attempt (which happens more often than not), the user must then remove the replacement wheel and try it again which results in more manual lifting. This is time consuming and may also result in injury as the user has to repeat the manual lifting of the heavy replacement wheel.

Therefore, there is provided a novel wheel mounting guide bar that provides assistance to a user when replacing a wheel.

### SUMMARY

The disclosure is directed at a wheel mounting guide bar. In one aspect of the disclosure, there is provided a wheel mounting guide bar including a shaft portion; a sleeve portion, the sleeve portion sized to fit a stud on a wheel hub; and a connector connecting the shaft portion to the sleeve portion, the connector enabling the sleeve portion to move with respect to the shaft portion.

In another aspect, the bar further includes a handle portion, the handle portion connected to the shaft portion at an end of the shaft portion opposite the sleeve portion. In yet another aspect, the bar further includes a second sleeve portion; and a second connector, the second connector connected the second sleeve portion to the shaft portion at an end of the shaft portion opposite the sleeve portion. In a further aspect, the bar further includes a guard portion, the guard portion surrounding a portion of the shaft portion. In yet another aspect, the guard portion is a rubber guide portion. In an aspect, the sleeve portion includes a hollow portion for receiving a stud located on a wheel hub of a vehicle.

### BRIEF DESCRIPTION OF THE DRAWINGS

Some embodiments of the present disclosure are illustrated as an example and are not limited by the figures of the accompanying drawings, in which like references may indicate similar elements and in which:

FIG. 1 is a side view of a first embodiment of a wheel mounting guide bar;

FIG. 2 is a side view of a second embodiment of a wheel mounting guide bar;

FIG. 3 is a side view of a third embodiment of a wheel mounting guide bar;

FIG. 4 is a view of a sleeve portion of a wheel mounting guide bar;

FIG. 5a is a view of another embodiment of an interchangeable sleeve portion attached to a guide bar;

FIG. 5b is a view of the interchangeable sleeve portion detached from the guide bar;

FIG. 6a is a schematic view of a wheel mounting guide bar in an operational environment; and

FIG. 6b is another schematic view of a wheel mounting guide bar in an operational environment;

FIG. 6c is a perspective view of a wheel mounting Figure guide bar in an operational environment;

FIG. 7 is a perspective view of another embodiment of a sleeve portion connected to a shaft portion; and

FIG. 8 is a perspective view of another embodiment of a wheel mounting guide bar.

### DETAILED DESCRIPTION

The disclosure is directed at a wheel mounting guide bar that includes a handle or handle portion, a bar or shaft portion and a sleeve portion. While the term “wheel” generally refers to a rim and the term “tire” represents the rubber portion that is installed on the wheel or rim, for the following description, the term “wheel” will be used to represent the combination of a tire and rim.

In some embodiments, the sleeve portion is connected to the shaft portion via a swivel, joint or elbow connector whereby the sleeve portion can move or pivot with respect to the shaft portion. In some embodiments, the sleeve portion may be permanently attached to the shaft portion while, in other embodiments, the sleeve portion may be removable such that it can be replaced by another sleeve portion to accommodate different sized studs of different vehicle wheel hubs or based on damage to an existing sleeve portion. For the embodiments where the sleeve portion may be removable, the connection may be via a threaded connection. In some embodiments, the sleeve portion is designed to fit between a stud hole within a wheel and over the corresponding stud on the wheel hub.

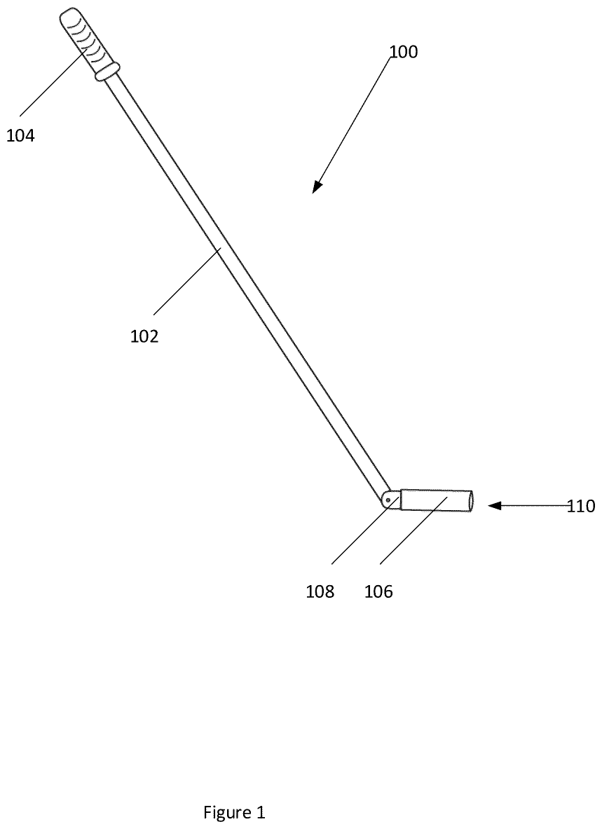

Turning to FIG. 1, a side view of a first embodiment of a wheel mounting guide bar is shown. The wheel mounting guide bar 100 of FIG. 1 may be seen as an automotive guide bar.

The wheel mounting guide bar 100 includes a bar, or shaft, portion, 102 that has a handle portion 104 attached at one end and a sleeve portion 106 attached at an opposite end. The handle portion 104 may be rubberized to provide a more comfortable grip to a user of the guide bar 100. In other embodiments, the handle portion 104 may be designed for safety and comfort whereby the handle portion 104 protects a user's hand from pinching if the replacement wheel slides back along the shaft portion 102. In some embodiments, the handle portion can be removed and/or replaced.

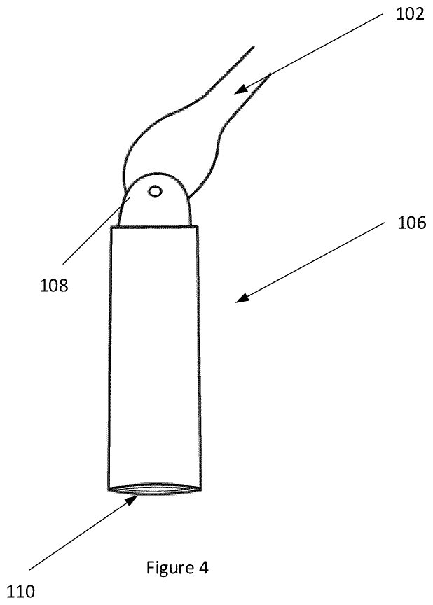

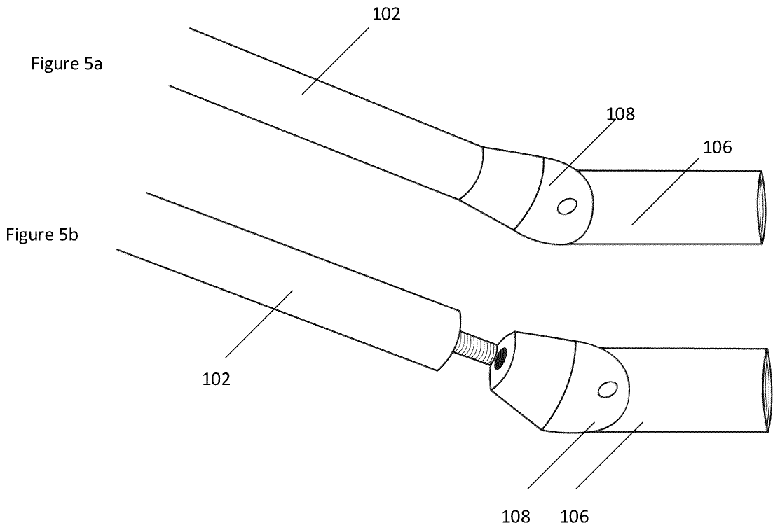

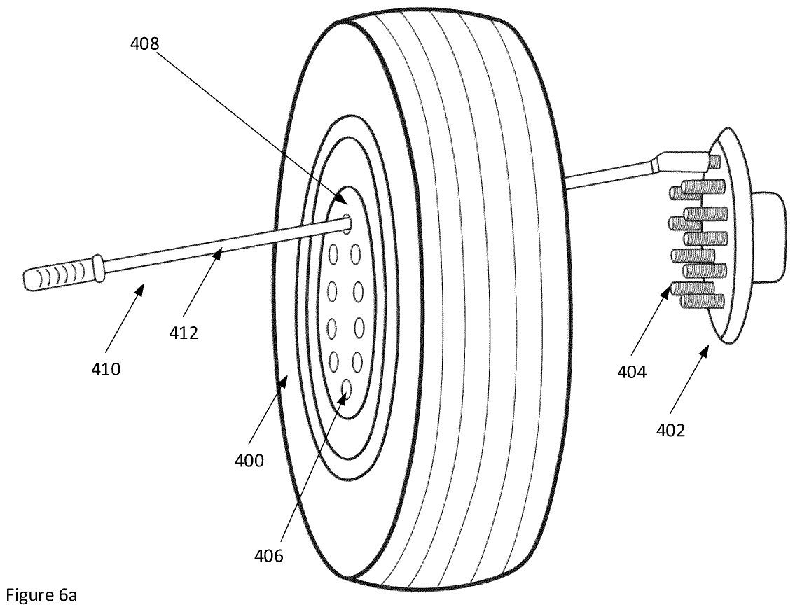

The sleeve portion 106 is connected via a swivel, joint or elbow connector 108 either in a permanent or removable connection. For embodiments where the sleeve portion 106 can be removed or replaced, when required, such as to accommodate a different sized wheel nut or stud, the sleeve portion 106 may be connected to the shaft portion 102 via a threaded connection. FIG. 4 is a perspective view of a sleeve portion 106 connected to the shaft portion 102 via a permanent connector 108 (such as, but not limited to, a weld) while FIGS. 5a and 5b are perspective views of a sleeve portion 106 connected to the shaft portion 102 via a threaded connector 108 (FIG. 5a) and detached from the shaft portion 102 (FIG. 5b).

The sleeve portion 106 includes an opening or hollow portion 110 (away from the connector 108) that is sized to receive a stud or nut located on a wheel hub. A set of studs (and corresponding lug nuts) is used to keep a wheel mounted in place on the vehicle by attachment of a lug nut over each stud after the replacement wheel has been mounted. Depending on the type of vehicle and/or the size of the studs on the wheel hub, the hollow portions 110 are sized to fit these known sizes of studs. In some embodiments, the sleeve portion 106 is a specific size to be able to fit through the stud holes on the wheel, and over the studs on the hub.

In some embodiments, the wheel mounting guide bar 100 may be designed to work with European style wheel hubs where the sleeve portion is replaced by a guide pin. In these embodiments, the guide pin is inserted through the threaded stud holes on the wheel hub thereby guiding the replacement wheel onto the hub.

With respect to guide bar 100, in a specific embodiment, a diameter of the shaft portion 102 is about 12 mm and a length of the shaft portion 102 is about 3 feet. In other embodiments, the diameter of the shaft portion 102 is designed to comfortably slide through a stud hole within the replacement wheel. As a length of the shaft portion 102 affects the leverage that a user can apply, the longer the shaft portion 102, the easier it will be for the replacement wheel to be lifted by the user. A material of the shaft portion 102 is selected such that it is durable and/or dense enough to hold a weight of the replacement wheel, such as a dense metal. In some embodiments, the shaft portion 102 may include a protective plastic coating to avoid damage to the replacement wheel when being used.

In some embodiments, the hollow portion 110 of different sleeve portions 106 is sized to fit or receive 12 mm to 16 mm studs. In some embodiments, the sleeve portion 106 is made from a durable metal and may have a finished coating on its surface.

Design of the automotive wheel mounting guide bar 100 is such that it is able to withstand a weight of a heavy passenger truck wheel while being able to fit through smaller sized stud holes of smaller replacement wheels.

As will be understood, different guide bars may be manufactured for different sized vehicles makes and models where shaft length and diameter depend on vehicle and tire size. In other embodiments, the sleeve portion 106 may be of different circumferences depending on a size of stud and wheel stud holes that is designed to accommodate. In some embodiments, a cone shape is connected between the sleeve portion 106 and a swivel connector 108 to enable a smoother installation of a replacement wheel. In these embodiments, a diameter of the shaft portion and the connector may not be uniform with the sleeve portion which is a tapered cone shape to ensure the replacement wheel has a smooth transition from the shaft portion to the sleeve portion. This is described in more detail below.

In another embodiment of the guide bar 100, the sleeve portion 106 may be interchangeable on the tool 100 to adapt to different size vehicles and studs whereby a single guide bar 100 can be connected to different sleeve portions so that only a single guide bar is able to handle multiple sizes of tire studs.

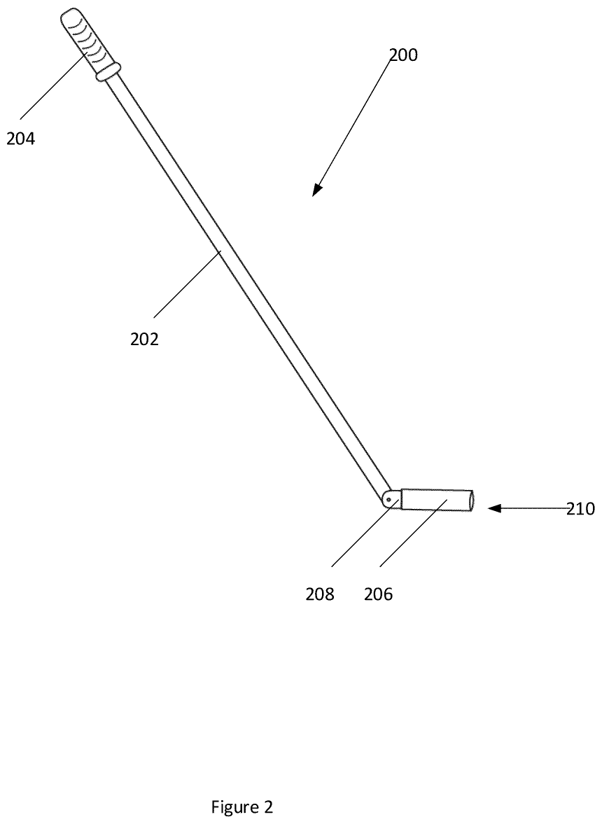

Turning to FIG. 2, a side view of a second embodiment of a wheel mounting guide bar is shown. In the current embodiment, the wheel mounting guide bar 200 of FIG. 2 may be seen as a commercial guide bar. The wheel mounting guide bar 200 includes a bar, or shaft portion, 202 that has a handle portion 204 that is attached at one end and a sleeve portion 206 attached at an opposite end. The sleeve portion 206 is connected via a swivel, joint or elbow connector 208, either in a permanent connection or in a removable connection whereby the sleeve portion 206 can be changed when required, such as to accommodate a different sized wheel stud or nut. The sleeve portion 206 includes an opening or hollow portion 210 (away from the connector 208) that is sized to receive a stud that is used to keep a wheel mounted in place.

With respect to the commercial guide bar in FIG. 2, in one specific embodiment, a diameter of the shaft portion 202 is about 18 mm and a length of the shaft portion 202 is about 4 feet. The hollow portion 210 of the sleeve portion 206 may be sized to receive 18 mm to 22 mm studs. As will be understood, the sleeve portions 206 may be interchangeable such that the guide bar 200 can be used for different vehicle types and different stud sizes.

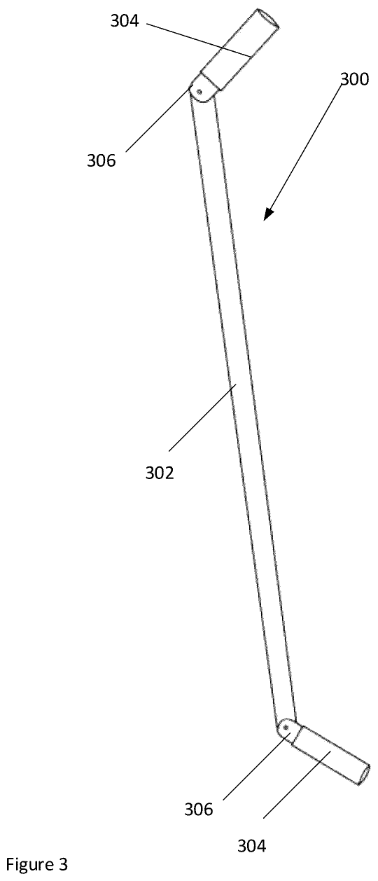

Turning to FIG. 3, another embodiment of a wheel mounting guide bar is shown. The dual sleeve wheel mounting guide bar 300 of FIG. 3 includes a bar, or shaft, portion 302 which is connected at both ends to sleeve portions 304 via joint, swivel or hinge connectors 306. As with the sleeve portions described above, the sleeve portions 304 include hollow portions for mating with studs that are located on a wheel hub. In this embodiment, the user can grip the bar portion when using the guide bar 300 to replace a wheel.

In some embodiments, the size of the sleeve portions 304 are different such that the guide bar 300 may be suitable for use with two different sizes of studs without a need to exchange the sleeve portion 304. The sleeve portions 304 may act as handle portions when the opposite sleeve portion 304 is in use. The shaft portion 302 may include a rubber cover or guard in order to provide an improved grip to a user or it may be uncovered. This guard can be moved along the shaft portion depending on what sleeve portion is needed or being used

This embodiment may be seen as a wheel mounting guide bar with an elongated metal shaft portion with swivel connectors and sleeve portions at both ends.

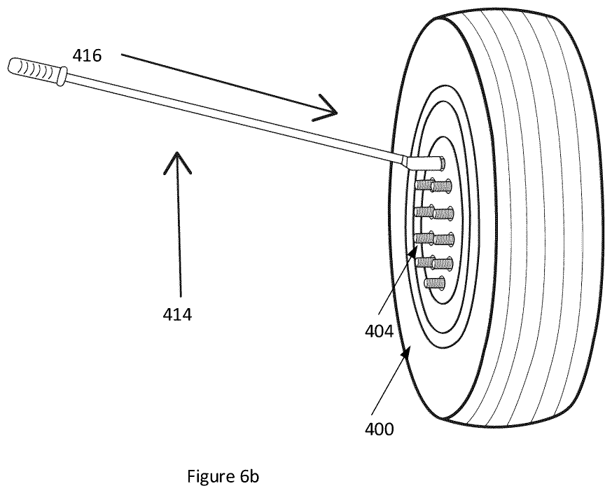

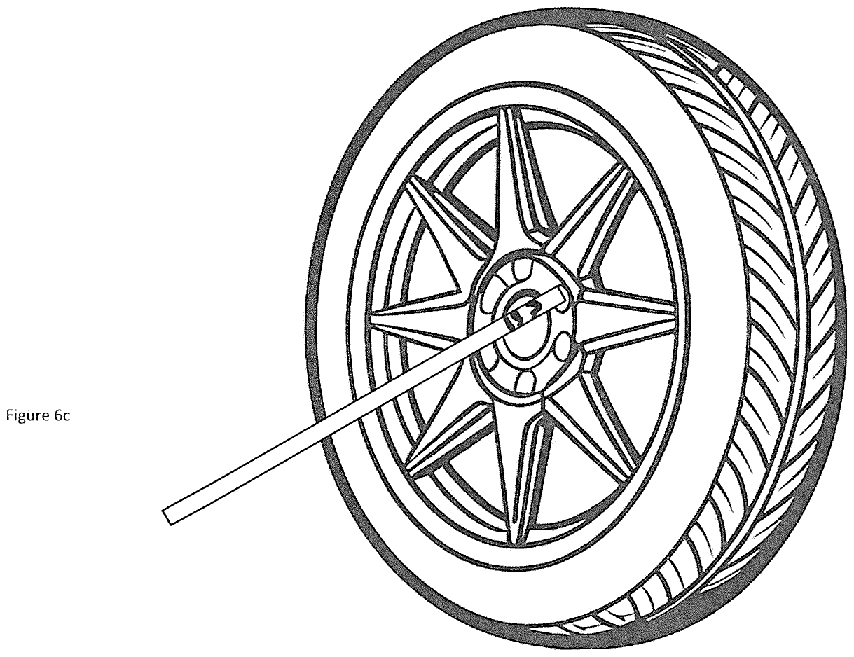

Turning to FIG. 6a, a schematic diagram of a wheel mounting guide bar within an operational or wheel changing environment is provided. In the environment of FIG. 6a, it is assumed that the old wheel has already been removed from the vehicle.

Operation of a wheel mounting guide bar 410, such as the automotive wheel mounting guide bar 100, the commercial wheel mounting guide bar 200 or the dual sleeve wheel mounting guide bar 300 is now described. As shown in FIG. 6a, the wheel mounting guide bar 410 is either the automotive wheel mounting guide bar 100 or the commercial wheel mounting guide bar 200.

Prior to installation or mounting, the new or replacement wheel 400 is placed in a position substantially parallel to a wheel hub 402 of a vehicle. Although not shown, the wheel hub 402 is attached to a vehicle within a wheel well of the vehicle. The wheel hub 402 includes a set of studs 404 which equal or correspond with a set of holes (which may also be seen as stud holes) 406 within a rim 408 of the wheel 400.

After positioning the replacement wheel 400, the user can then slide or direct the wheel mounting guide bar 410 through one of the holes 406. In FIG. 6a, the wheel mounting guide bar 410 has been slid through a top stud hole. For wheel mounting guide bars 100 or 200, the user may hold the guide bar 410 via the handle portion and then direct the sleeve portion of the guide bar 410 through the hole 406 until it connects or mates with the corresponding stud 404 on the wheel hub 402. For the dual sleeve guide bar, the user may determine which sleeve portion is sized to fit with the studs 404 of the wheel hub 402 and then directs that sleeve portion through the hole 406 until it connects or mates with the corresponding stud. As discussed above, the sleeve portion or portions of each of the guide bars is/are sized to fit within or through a stud hole in the replacement wheel and over the corresponding stud on the wheel hub.

As shown in FIG. 6a, when the sleeve portion is placed over the stud, the shaft portion 412 is positioned within the stud hole 406. As the connector between the shaft portion and the sleeve portion is able to pivot, swivel or move or enables the sleeve portion to pivot, swivel or move with respect to the shaft portion, a position of the sleeve portion can be more easily manipulated. This is helpful when the stud holes and the studs are not perfectly aligned from a horizontal standpoint.

As schematically shown in FIG. 6b, once the sleeve portion has been connected over the stud, the user lifts the shaft portion (for example in the direction of arrow 414, such as by lifting the bar 410 via the handle portion (guide bars 100 and 200) or the opposite sleeve portion (guide bar 300) to direct the replacement wheel 400 towards the wheel hub in the direction of arrow 416. It is understood that a user may also grip the shaft portion of the bar 410 to lift the replacement wheel. Based on that leveraging and gravity, the replacement wheel may then slide down the shaft portion and over the sleeve portion towards the wheel hub facilitating the mounting of the remaining studs holes onto their corresponding studs on the wheel hub. In one embodiment, after the replacement wheel 400 has slid down the shaft portion, the user may push the replacement wheel over the wheel hub whereby the studs pass through their corresponding stud holes such that the stud locks, or lug nuts, may be fastened to the studs. FIG. 6c provides a perspective view of the wheel mounting guide bar in an operational environment.

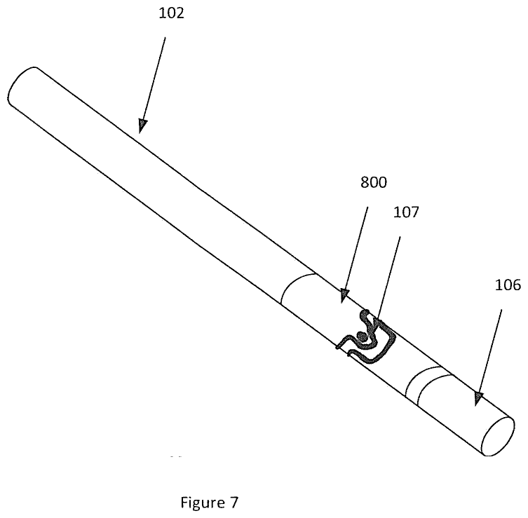

Turning to FIG. 7, a perspective view of another embodiment of a sleeve portion connected to a shaft portion is shown. As can be seen, the shaft portion 102 is connected via a connector 108 to the sleeve portion 106. The connector 108 includes a hinged connector portion 700 that allows the shaft portion 102 and the sleeve portion 106 to pivot or move with respect to each other.

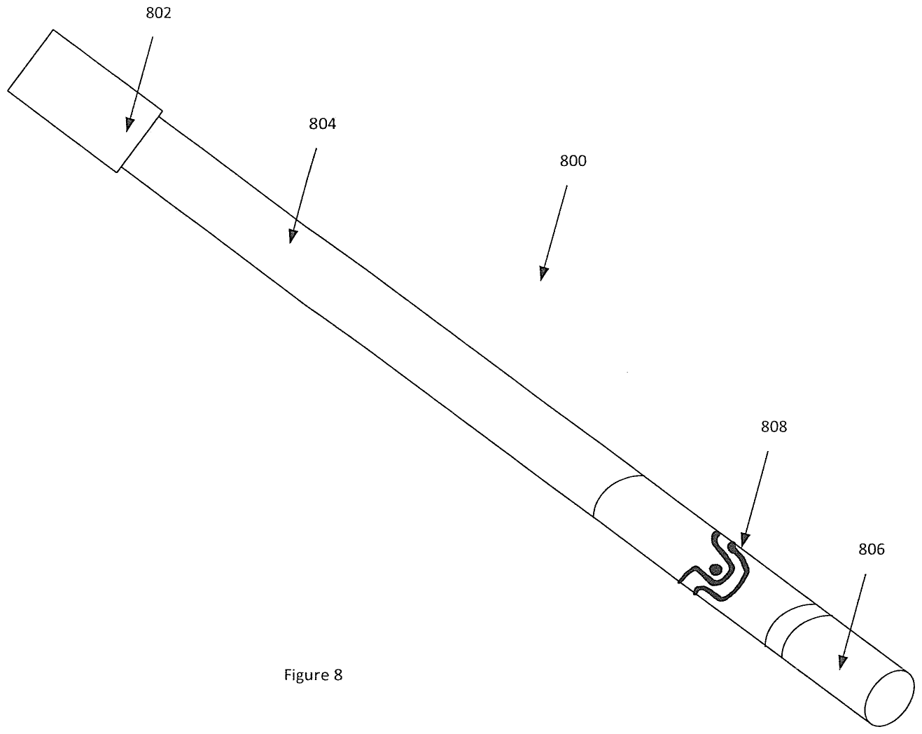

Turning to FIG. 8, a perspective view of another embodiment of a wheel mounting guide bar is shown. In the current embodiment, the guide bar 800 includes a handle portion 802, a shaft portion 804 and a sleeve portion 806. The sleeve portion 806 is connected to the shaft portion 804 via a connector 808 that enables the sleeve portion 806 to pivot or swivel with respect to the shaft portion 804.

In one embodiment, the wheel mounting guide tool 410 is used to alleviate the struggle of mounting a replacement wheel onto a wheel hub. Using leverage to lift the replacement wheel, minimizes or reduces the likelihood of injuries due to the need for a user to lift the entire weight of the replacement wheel with their arms. Using a wheel mounting guide tool 410 of the disclosure to guide the replacement wheel into the proper position not only minimizes or reduces the likelihood of injury, use of the guide tool may also increase the ease of which the replacement wheel falls into position with respect to the wheel hub. In some embodiments, the sleeve portion may also act as a centering pin if the user leaves the guide tool 410 in place over the stud while torquing up or tightening the surrounding nuts on other studs before removing the guide bar 410.

While various embodiments have been described above, it should be understood that they have been presented only as illustrations and examples of the present disclosure, and not by way of limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments but should be defined only in accordance with the appended claims and their equivalents. It will also be understood that each feature of each embodiment discussed herein, and of each reference cited herein, can be used in combination with the features of any other embodiment.

Applicants reserve the right to pursue any embodiments or sub-embodiments disclosed in this application; to claim any part, portion, element and/or combination thereof of the disclosed embodiments, including the right to disclaim any part, portion, element and/or combination thereof of the disclosed embodiments; or to replace any part, portion, element and/or combination thereof of the disclosed embodiments.

The above-described embodiments are intended to be examples only. Alterations, modifications and variations can be effected to the particular embodiments by those of skill in the art without departing from the scope, which is defined solely by the claims appended hereto.

What is claimed is:

1. A wheel mounting guide bar comprising:
a shaft portion;
a sleeve portion, the sleeve portion sized to fit a stud on a wheel hub; and
a connector connecting the shaft portion to the sleeve portion, the connector enabling the sleeve portion to move with respect to the shaft portion.

2. The wheel mounting guide bar of claim 1 further comprising:
a handle portion, the handle portion connected to the shaft portion at an end of the shaft portion opposite the sleeve portion.

3. The wheel mounting guide bar of claim 1 further comprising:
a second sleeve portion; and
a second connector, the second connector connected the second sleeve portion to the shaft portion at an end of the shaft portion opposite the sleeve portion.

4. The wheel mounting guide bar of claim 3 further comprising:
a guard portion, the guard portion surrounding a portion of the shaft portion.

5. The wheel mounting guide bar of claim 4 wherein the guard portion is a rubber guide portion.

6. The wheel mounting guide bar of claim 1 wherein the sleeve portion comprises a hollow portion for receiving a stud located on a wheel hub of a vehicle.
